(19) United States
(12) Patent Application Publication
(10) Pub. No.: US 2009/0323619 A1
(43) Pub. Date: Dec. 31, 2009

(54) DISTRIBUTED BEAMFORMING AND RATE ALLOCATION IN MULTI-ANTENNA COGNITIVE RADIO NETWORKS

(75) Inventors: Ali Tajer, New York, NY (US); Narayan Prasad, Monmouth Junction, NJ (US); Xiaodong Wang, New York, NY (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/493,044

(22) Filed: Jun. 26, 2009

Related U.S. Application Data
(60) Provisional application No. 61/075,874, filed on Jun. 26, 2008.

(51) Int. Cl. H04W 72/00

(52) U.S. Cl. 370/329; 455/63.1

(57) ABSTRACT

Systems and methods are disclosed for designing beamforming vectors for and allocating transmission rates to secondary users in a wireless cognitive network with secondary (cognitive) users and primary (license-holding) users by performing distributed beamforming design and rate allocation for the secondary users to maximize a minimum weighted secondary rate; and granting simultaneous spectrum access to the primary and secondary users subject to one or more co-existence constraints.

This application claims priority to Provisional Application Ser. No. 61/075,874, filed Jun. 26, 2008, the content of which is incorporated by reference.

### BACKGROUND

The present invention relates to a cognitive radio network.

In classical cognitive radio systems the secondary users can only transmit in white spaces which denote the frequency bands (or time intervals) where the primary (or licensed) users are silent. On the other hand, in generalized cognitive radio systems, the secondary users can also transmit simultaneously with primary users, as long as certain co-existence constraints are satisfied. The latter systems can achieve higher spectral efficiencies but at the expense of additional side-information at the secondary users and increased signaling overhead.

In prior attempts the beamformers for the cognitive users are designed by a central node having full knowledge of all the network channel conditions. In another line of work, a semi-distributed design of the beam vectors (beamformers) is considered but where such design is independent of the effect of the transmissions by the cognitive users on the reception quality of primary users and only satisfies some constraints on the quality of service (QoS) of the cognitive users. For fair rate allocation with a given choice of beamformers, there exist distributed algorithms which are optimal under some notions of fairness but the complexities of all such algorithms increase exponentially with the number of users.

### SUMMARY

Systems and methods are disclosed for designing beamforming vectors for and allocating transmission rates to secondary users in a wireless cognitive network with secondary (cognitive) users and primary (license-holding) users by performing distributed beamforming design and rate allocation for the secondary users to maximize a minimum weighted secondary rate; and granting simultaneous spectrum access to the primary and secondary users subject to one or more co-existence constraints.

In another aspect, a method for allocating transmission rates in a wireless network where secondary (cognitive) users are granted simultaneous spectrum access along with primary (license-holding) users by: determining the beamformers and rates in a distributed fashion for the case when single user decoding is employed at each secondary receiver; and performing distributed allocation of excess rates to the secondary users, for the choice of beamformers generated above, wherein the excess rate allocation maintains a notion of fairness.

In yet another aspect, a wireless system includes a plurality of users, each having a transmitter and a receiver, wherein the secondary users are allowed to use the spectrum or bandwidth licensed to the primary users concurrently and wherein secondary transmitter beamformers are designed to ensure that the interference seen by individual primary receivers does not exceed the specified levels, a minimum quality of service (QoS) is guaranteed for each secondary user and a weighted sum of the powers used by the secondary transmitters is minimized or the worst case QoS among all cognitive users is maximized.

In yet another aspect, a cognitive radio network includes transmitters and receivers which are equipped with multiple transmit and receive antennas, respectively. The secondary (or cognitive) users are allowed to use the spectrum or bandwidth licensed to the primary users concurrently (a.k.a. underlaid spectrum access). The beamformers for the cognitive transmitters are designed such that:

1—The interference seen by individual primary receivers does not exceed the specified levels.

2—A minimum quality of service (QoS) is guaranteed for each secondary user.

3—A weighted sum of the powers used by the cognitive transmitters is minimized or the worst case QoS among all cognitive users is maximized.

For any given choice of beamformers, the system runs computationally efficient distributed processes for fair rate allocation among the cognitive users.

The optimization criteria take into account the effect of the secondary users' transmissions on the primary users and satisfy QoS constraints for both types of users. Also, each individual cognitive user carries out its own beamformer design in a distributed fashion, with limited message passing among secondary transceiver pairs, which obviates the need for having a central controller in charge of designing the beamformers.

The system can use distributed rate allocation algorithms which for any given choice of beamformers achieve optimal fair rate allocations and complexities are polynomial in the number of users.

Advantages of embodiments of the system may include one or more of the following. The system provides distributed procedures for designing beamformers as well as distributed algorithms for fair rate allocation for any given choice of beamformers, which substantially lower system complexity as well as cost and also increase the spectral efficiency. The distributed rate allocation methods used for any given choice of beamformers, reduce the complexity at each secondary receiver which scales polynomially in the number of secondary users.

### BRIEF DESCRIPTION OF THE DRAWINGS

FIG. 1 shows an exemplary cognitive radio network.

FIG. 2 shows an exemplary process for joint beamforming design and rate allocation.

FIG. 3 shows an exemplary distributed max-min fair rate allocation process.

### DESCRIPTION

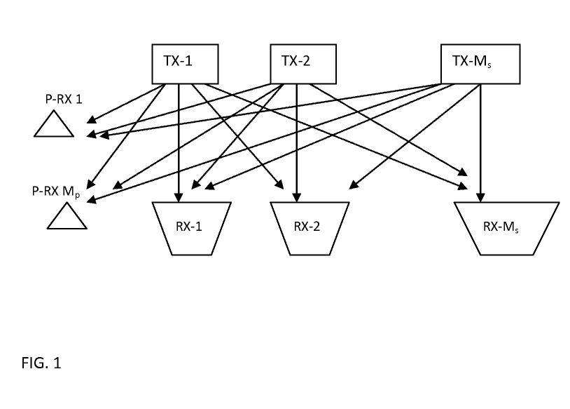

FIG. 1 shows an exemplary cognitive radio network where multiple transceiver pairs TX1-RX1, . . . TXMₛ-RXMₛ communicate simultaneously over the same bandwidth. In one embodiment, the network is a decentralized multi-antenna cognitive radio network where secondary transceivers can co-exist with primary ones. The decentralized cognitive network has Mₛ secondary transmitter-receiver pairs co-existing with Mₚ primary transceiver pairs via concurrent spectrum access. The secondary transceivers form a multi-antenna Gaussian interference channel (GIC) where Mₛ transmitters each equipped with Nₛ transmit antennas communicate with their designated (effective) single-antenna receivers. The primary transmitters and receivers have Nₚ and 1 transmit and receive antennas, respectively.

Each transmitter (user) wants to communicate with its desired receiver. For instance in FIG. 1, transmitter m wants to communicate with receiver m. The signal transmitted by any transmitter is received by all receivers RX1, . . . RXM, and P-RX1, . . . , P-RXMₚ after being corrupted by the propagation environment as well as additive Gaussian noise. The Mₛ secondary transceiver pairs communicate simultaneously on the same channel as Mₚ primary transceiver pairs.

In this embodiment, no secondary transmitter has access to any primary user's transmitted message or its codebook. Instead, each secondary transmitter employs beamforming to communicate with its desired receiver while ensuring that the aggregate interference seen by each primary receiver does not exceed a specified level (interference margin). Optimal beamformers are generated for the secondary users and rates are assigned in a distributed fashion, in order to maximize the smallest weighted rate among secondary users, subject to a weighted sum-power constraint for the secondary users as well as the interference margin constraints imposed by the primary users. The system provides beamforming vectors, one for each secondary transceiver pair, given the set of all channel coefficients, the choice of primary beamforming vectors, the interference margin at each primary receiver, the power constraint for the secondary transmitters and the decoders employed by the secondary receivers, such that a utility for the secondary transceiver pairs is maximized and the primary interference margin constraints are satisfied.

In the decentralized multi-antenna cognitive radio network, secondary (cognitive) users are granted simultaneous spectrum access along with license-holding (primary) users. The distributed beamforming design for the secondary users is done such that the minimum weighted secondary rate is maximized. The resulting optimization is subject to a limited weighted sum-power budget for the secondary users and guaranteed protection for the primary users in that the interference level imposed on each primary receiver does not exceed a certain specified level. Based on the decoding scheme deployed by the secondary receivers, three scenarios are handled: the first one allows only single-user decoding at each secondary receiver, in the second case each secondary user employs the maximum likelihood decoder (MLD) to jointly decode all secondary transmissions and in the third one each secondary receiver uses the unconstrained group decoder (UGD), where it is allowed to jointly decode any subset of secondary users containing its desired user after decoding and canceling any other subsets, as deemed beneficial. An optimal distributed beamforming algorithm for the first scenario (with single-user decoding) is provided, and explicit formulations of the optimization problems for the latter two ones (with MLD and UGD, respectively) which however are non-convex. For the case with MLD, a centralized sub-optimal beamforming design is proposed. Further, for the case with MLD or UGD, a two-stage sub-optimal distributed algorithm can be used. In the first stage, the beamformers are determined in a distributed fashion after assuming single user decoding at each secondary receiver and corresponding rates are determined. By using these beamformer designs, MLD often and UGD always allows for supporting rates higher than those achieved in the first stage. The second stage uses optimal distributed low-complexity algorithms to allocate excess rates to the secondary users, given the beams determined in the first stage, such that a notion of fairness is maintained. Simulation results, as detailed in the incorporated by reference provisional patent application, demonstrate the gains yielded by the rate allocation as well as the beamformer design methods.

The beamforming design problems for the MLD and UGD, respectively, are non-linear non-convex problems and even centralized algorithms are not guaranteed to yield globally optimal solutions. Motivated by this fact and more importantly by the necessity for having a distributed process, an alternative two-stage suboptimal approach is used in the preferred embodiment.

First, the system obtains the beamforming vectors via Algorithms 1 and 2 which provide the optimal beamformers for the case when the secondary users employ MMSE receivers (single user decoding). In the second stage, for the given choice of beamformers, the system exploits the fact that MLDs or UGDs are used at each receiver and allocates excess rates to secondary users in a distributed fashion. Pseudo-code for Algorithm 1 is as follows:

Algorithm 1-Solving [symbol] (γ)

| | |
|---|---|
| 1: | Input α, γ, β, and {h_{i,j}^{s,s}}, {h_{i,j}^{s,p}}, {h_{i,j}^{p,s}}, {h_{i,j}^{p,p}} |
| 2: | Define {\tilde{h}_{i,j}^{s,s}}, {\tilde{h}_{i,j}^{p,s}} as specified in (9) |
| 3: | Initialize λ and k = 1 |
| 4: | repeat |

| | |
|---|---|
| 5: | Construct Uᵢ as in (13); obtain ĥ_{j,i}^{s,s} = \tilde{h}_{j,i}^{s,s}Uᵢ⁻¹ |
| 6: | Solve g(λ) using the distributed algorithm of [7] |
| | and find {ŵᵢ^{s}} |
| 7: | Obtain {\tilde{w}ᵢ^{s}} using transformation \tilde{w}ᵢ^{s} = Uᵢ⁻¹ŵᵢ^{s} |
| 8: | Calculate the subgradient s^{(k)} as in (17) |
| 9: | $Update {λ}^{( k + 1 )} = {λ}^{( k )} - \frac{1}{k} {s}^{( k )} and k ← k + 1$ |

| | |
|---|---|
| 10: | until convergence |
| 11: | $Output \{ {w}_{i}^{s} \} = \{ \frac{1}{\sqrt{{α}_{i}}} {\tilde{w}}_{i}^{s} \} and 𝒫 ( γ ) = {\sum }_{i} {α}_{i} {‖ {w}_{i}^{s} ‖}^{2}$ |

The procedure in Algorithm 1 constructs secondary beam vectors which minimize the weighted secondary transmit sum power, where the weights for secondary powers is specified by the vector α, subject to secondary SINR constraints (specified by the vector γ) and primary interference margin constraints (specified by the vector β). The relevant equations involved in the procedure are:

$$\begin{matrix}{\tilde{w}}_{i}^{s} {=}^{Δ} \sqrt{{α}_{i}} {w}_{i}^{s} and {\tilde{h}}_{i , i}^{s , s} {=}^{Δ} \frac{{h}_{i , i}^{s , s}}{\sqrt{{α}_{i} {γ}_{i}}} for i = 1 , … , {M}_{s} , \\ {\tilde{h}}_{i , j}^{p , s} {=}^{Δ} \frac{{h}_{i , j}^{p , s}}{\sqrt{{β}_{i} {α}_{j}}} for i = 1 , … , {M}_{p} and j = 1 , … , {M}_{s} , \\ and \\ {\tilde{h}}_{i , j}^{s , s} {=}^{Δ} \frac{{h}_{i , j}^{s , s}}{\sqrt{{α}_{j}}} for i \neq j , i , j = 1 , … , {M}_{s} . & ( 9 ) \\ {U}_{i}^{H} {U}_{i} = I + {\sum }_{j = 1}^{{M}_{p}} {( {\tilde{h}}_{j , i}^{p , s} )}^{H} {\tilde{h}}_{j , k}^{p , s} {λ}_{j} . & ( 13 ) \\ {s}_{j}^{( k )} = 1 - {\sum }_{i = 1}^{{M}_{s}} {\vert {\tilde{h}}_{j , i}^{p , s} {ω}_{i} \vert}^{2} , for j = 1 , … , {M}_{p} , where \{ {ω}_{i} \} = arg {min}_{\{ {\tilde{w}}_{i}^{s} \} ∈ {D}_{\{ {\tilde{h}}_{i , j}^{s , s} \}}} L ( \{ {\tilde{w}}_{i}^{s} \} , {λ}^{( k )} ) , \\ L ( \{ {\tilde{w}}_{i}^{s} \} , λ ) = {\sum }_{i = 1}^{{M}_{s}} {‖ {\tilde{w}}_{i}^{s} ‖}^{2} + {\sum }_{j = 1}^{{M}_{p}} {λ}_{j} [ {\sum }_{i = 1}^{{M}_{s}} {\vert {\tilde{h}}_{j , i}^{p , s} {\tilde{w}}_{i}^{s} \vert}^{2} - 1 ] = {\sum }_{i = 1}^{{M}_{s}} {( {\tilde{w}}_{i}^{s} )}^{H} [ I + {\sum }_{j = 1}^{{M}_{p}} {( {\tilde{h}}_{j , i}^{p , s} )}^{H} {\tilde{h}}_{j , i}^{p , s} {λ}_{j} ] {\tilde{w}}_{i}^{s} - {\sum }_{j = 1}^{{M}_{p}} {λ}_{j} & ( 17 )\end{matrix}$$

Using Algorithm 1, along with a bisection search, in Algorithm 2 the system solves the optimization problem R(P0) to maximize the minimum weighted secondary rate under a secondary weighted sum power constraint and primary interference margin constraints. For initializing Algorithm 2, the lower and upper bounds on the (optimal) R(P0), denoted as ρₘᵢₙ and ρₘₐₓ, respectively, are used. For computing both the bounds, initial beamforming vectors are obtained via channel matching, i.e., in the process the initial beamforming vector of the secondary transmitter i, wᵢ^{s}, is set to be a scalar multiple of (hᵢ^{s,}ᵢ^{s})^{H}/∥hᵢ^{s,}ᵢ^{s}∥. In particular, for obtaining ρₘᵢₙ, the process sets wᵢ^{s}={square root over (\hat{α}(h_{i,}^{s,}ᵢ^{s})^{H}/∥h_{i,}^{s,}ᵢ^{s}∥, ∀i, where \hat{α} is the largest positive scalar such that the power and margin constraints are satisfied. For obtaining ρₘₐₓ, it is assumed that the transmission intended for any particular secondary receiver causes no interference to any other receiver and can use all the available power, so that the optimal secondary beamformers are

$$\{ \frac{{{P}_{o} ( {h}_{i , i}^{s , s} )}^{H}}{{α}_{i} ‖ {h}_{i , i}^{s , s} ‖} \} .$$

Algorithm 2 always returns a feasible ρ and wᵢ^{s}.

Pseudo-code for Algorithm 2 is as follows:

Algorithm 2-Solving [symbol] (P₀)

| | |
|---|---|
| 1: | Input α, ρ, β, δ and {h_{i,j}^{s,s}}, {h_{i,j}^{s,p}}, {h_{i,j}^{p,s}}, {h_{i,j}^{p,p}} |
| 2: | $\begin{matrix}Initialize {ρ}_{mi n} = \\ {min}_{1 \leq i \leq {M}_{s}} \{ log ( 1 + \frac{\hat{α} {‖ {h}_{i , i}^{s , s} ‖}^{2}}{\hat{α} {\sum }_{j \neq i} {\vert {{h}_{i , j}^{s , s} ( {h}_{j , j}^{s , s} )}^{H} \vert}^{2} / {‖ {h}_{j , j}^{s , s} ‖}^{2} + {α}_{i}^{s}} ) / {ρ}_{i} \} and\end{matrix}$ |
| | ${ρ}_{max} = {min}_{1 \leq i \leq {M}_{s}} \{ log ( 1 + {P}_{0} \frac{{‖ {h}_{i , i}^{s , s} ‖}^{2}}{{α}_{i} ( {α}_{i}^{s} )} ) / ρi \}$ |

| | |
|---|---|
| 3: | ρ₀ ← ρₘᵢₙ, γ ← 2^{ρ}^{₀}^{ρ}− 1 |

| | |
|---|---|
| 4: | repeat |

| | |
|---|---|
| 5: | Solve [symbol] (γ) using Algorithm 1 |
| 6: | if P₀ ≧ [symbol] (γ) |

| | |
|---|---|
| 7: | ρₘᵢₙ ← ρ₀; update {wᵢ^{s}} |

| | |
|---|---|
| 8: | else |

| | |
|---|---|
| 9: | ρₘₐₓ ← ρ₀ |

| | |
|---|---|
| 10: | end if |
| 11: | ρ₀ ← (ρₘᵢₙ + ρₘₐₓ)/2 and γ ← 2^{ρ}^{₀}^{ρ}− 1 |

| | |
|---|---|
| 12: | until ρₘₐₓ − ρₘᵢₙ ≦ δ |
| 13: | Output [symbol] (P₀) = ρₘᵢₙ and {wᵢ^{s}} |

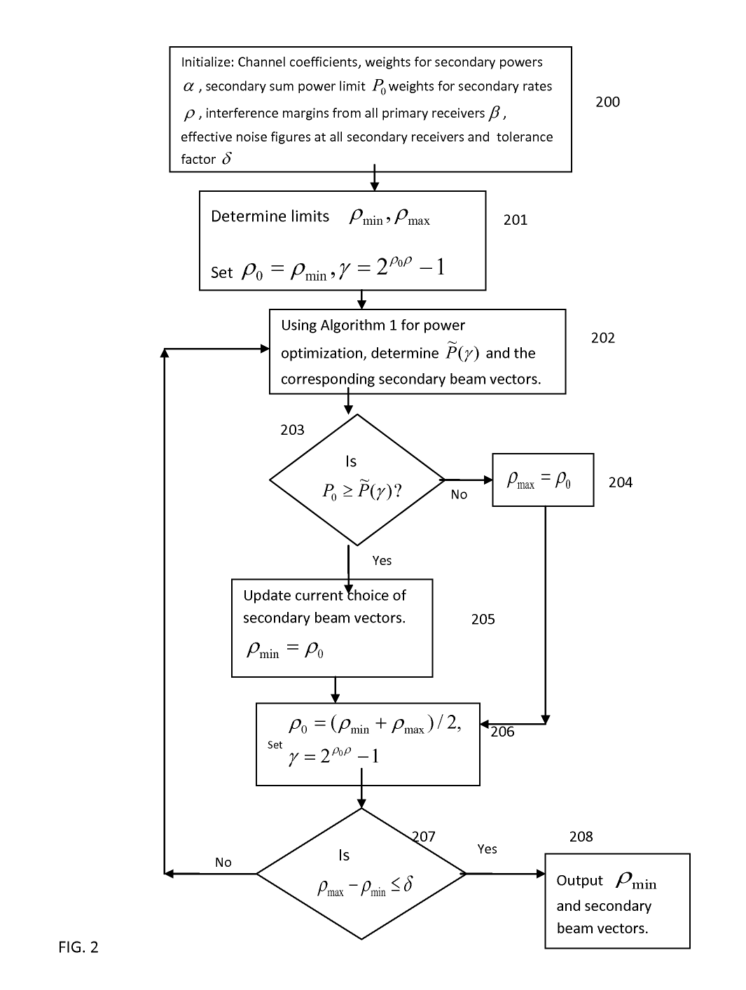

FIG. 2 shows an exemplary process for joint beamforming design and rate allocation for the case when the secondary users employ MMSE receivers (single user decoding). In 200, the process performs initialization by obtaining estimates of all channel coefficients, weights for secondary powers α, secondary sum power limit P₀, weights for secondary rates ρ, interference margins from all primary receivers β, effective noise figures at all secondary receivers (which include the interference due to primary beam vectors as well as thermal noise) and the tolerance factor δ. Next, in 201, the process determines limits ρₘᵢₙ, ρₘₐₓ and sets ρ₀=ρₘᵢₙ, γ=2^{ρ}^{₀}^{ρ}−1.

In 202, using the distributed procedure described in Algorithm 1, the process determines the weighted secondary sum power \tilde{P}(γ) and the corresponding secondary beam vectors. In 203, the process performs a condition check to see if P₀≧\tilde{P}(γ). If the condition is satisfied, the process proceeds to 204. Otherwise it proceeds to 205. In 204, the process updates the current choice of secondary beam vectors by selecting the ones obtained in 202. The process also sets ρₘᵢₙ=ρ₀ and jumps to 206. From 203, if the condition check is not satisfied, the process sets ρₘₐₓ=ρ₀ in 205 and proceeds to 206. In 206, the process sets ρ₀=(ρₘᵢₙ+ρₘₐₓ)/2, γ=2^{ρ}^{₀}^{ρ}−1.

Next, in 207, a condition check is conducted to see if ρₘₐₓ−ρₘᵢₙ≦δ. If the condition is satisfied, the process is deemed to have converged and proceeds to 208 where it outputs ρₘᵢₙ and secondary beam vectors. Otherwise, the process loops back to 202.

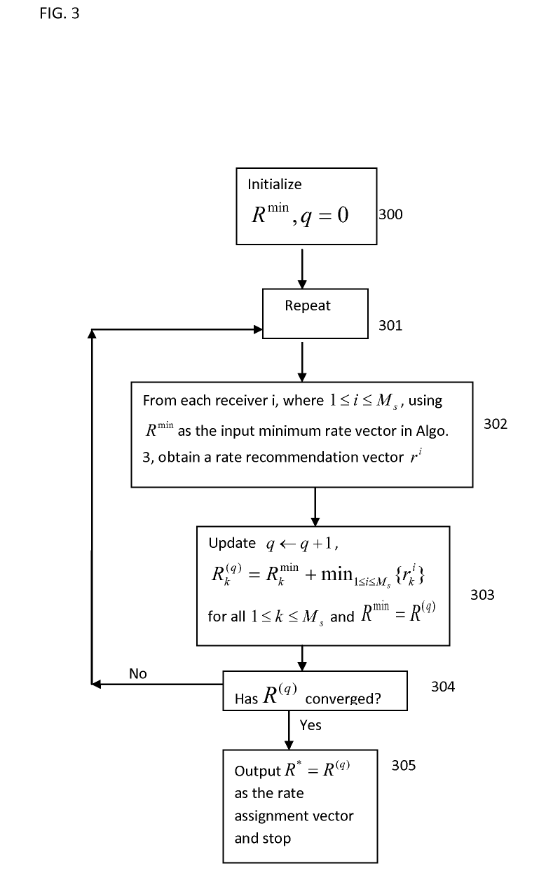

FIG. 3 shows an exemplary distributed max-min fair rate allocation process, which assigns excess rates to the secondary transceivers for a given choice of beamformers when the UGD is employed at each secondary receiver. In 300, the iterative rate-allocation process is initiated with a decodable minimum rate-allocation vector R^{min} and a counter q=0. In 301, the process enters a loop. In 302, from each receiver i, where 1≦i≦Mₛ, using R^{min} as the input minimum rate vector in Algorithm 3, the process obtains a rate recommendation vector rⁱ. Pseudo-code for Algorithm 3 is as follows:

Algorithm 3-Rate increment recommendations by individual receivers

| | |
|---|---|
| 1: | Initialize [symbol] = [symbol] and [symbol] = 0 and [symbol] ⁱ = 0 and k = 1, R^{min} |
| 2: | repeat |

| | |
|---|---|
| 3: | $Find {δ}^{k} = {min}_{B \neq 0 B ⊆ 𝒮} \frac{Δ ( {h}^{i} , B , 𝒢 , {R}^{min} )}{{\sum }_{j ε B} {ρ}_{j}} and$ ${B}^{k} = arg {min}_{B \neq 0 , B ⊆ 𝒮} \frac{Δ ( {h}^{i} , B , 𝒢 , {R}^{min} )}{{\sum }_{j ε B} {ρ}_{j}}$ |

If there are multiple choices for [symbol] ^{k} pick
any one such that i ∉ B^{k}

| | |
|---|---|
| 4: | if i ε [symbol] ^{k} or i ε [symbol] |

| | |
|---|---|
| 5: | rⱼⁱ = δ^{k}ρⱼ for all j ε [symbol] ^{k} and [symbol] ← [symbol] \ [symbol] ^{k} |
| | and [symbol] ← [symbol] ∪ [symbol] ^{k} and [symbol] ⁱ ← [symbol] ^{k} ∪ [symbol] ⁱ and k ← k + 1 |

| | |
|---|---|
| 7: | else |

| | |
|---|---|
| 8: | rⱼⁱ = +∞ for all j ε [symbol] ^{k}, [symbol] ← [symbol] \ [symbol] ^{k} |
| | and [symbol] ← [symbol] ∪ [symbol] ^{k}, k ← k + 1 |

| | |
|---|---|
| 9: | end if |

| | |
|---|---|
| 10: | until [symbol] = 0 |
| 11: | Output {rₖⁱ} and [symbol] ⁱ |

### In Algorithm 3,

$$K = \{ 1 , … , {M}_{s} \}$$

$$Δ ( {h}^{i} , S , B , {R}^{min} ) = log det [ I + {{h}_{S}^{{i}^{H}} ( 1 + {h}_{B}^{i} {h}_{B}^{{i}^{H}} )}^{- 1} {h}_{S}^{i} ] - {\sum }_{j ∈ S} {R}_{j}^{min} .$$

The rate vectors {rⁱ}ᵢ₌₁^{M}^{ₛ} can be computed at each respective receiver (or transmitter if it has the required knowledge of the channel and beam vectors) in parallel.

In 303, the counter is updated as q←q+1 and the rate of the k^{th} secondary user is updated as: Rₖ^{(q)=R}ₖ^{min}+min_{1≦i≦M}_{ₛ}{rₖⁱ} for all 1≦k≦Mₛ. The minimum rate vector is then updated: R^{min}=R^{(q)}. Next, in 304, a convergence check on R^{(q)} is conducted. If the rate vector has converged then the process goes to 305 otherwise it loops back to 301.

In 305, the rate-allocation vector R^{*}=R^{(q)} containing the rate assignment of each user is returned as an output and the process terminates.

In Algorithm 3, user i makes rate increment suggestions for all users (including itself) denoted by {r₁ⁱ, . . . , r_{M}_{ₛ}ⁱ }. Therefore, in each iteration of Algorithm 4, each user j receives Mₛ rate increment suggestions from all users and the j^{th} user picks the smallest rate increment suggested for it, i.e., min_{1≦i≦M}, rⱼ ⁱThe rate allocation R* yielded by Algorithm 4 is pareto-optimal and the algorithm has the following properties:
1) is monotonic in the sense that R^{(q+1)} [symbol] R^{(q)} and is convergent.
2) At each iteration the vector R^{(q)} is max-min optimal. i.e., for any other arbitrary decodable rate vector \tilde{R} [symbol] R^{min}

$${min}_{k ∈ K} \frac{{R}_{k}^{( q )} - {R}_{k}^{min}}{{ρ}_{k}} \geq {min}_{k ∈ K} \frac{{\tilde{R}}_{k} - {R}_{k}^{min}}{{ρ}_{k}} , ∀ q \geq 1.$$

3) The rate allocation R* yielded by Algorithm 4 is also pareto-optimal. i.e., for any arbitrary decodable rate vector \tilde{R} [symbol] R^{min} such that \tilde{R}ₖ>Rₖ* for some kεκ, ∃j≠k: \tilde{R}ⱼ<Rⱼ*.

Pseudo-code for Algorithm 4 is as follows:

Algorithm 4 - Distributed Weighted Max-Min Fair Rate Allocation

| | |
|---|---|
| 1: | Initialize R^{min} and q = 0 |
| 2: | repeat |
| 3: | for i = 1,...,Mₛ do |
| 4: | Run Algorithm 3 |
| 5: | end for |
| 6: | Update q ← q + 1 and Rₖ^{(q)} = |
| | Rₖ^{min} + min_{1≦i≦M}_{ₐ} {Tₖⁱ} and R^{min} ← R^{(q)} |
| 7: | until R^{(q)} converges |
| 8: | Output R* = R^{(q)} and {gⁱ}ᵢ₌₁^{M}^{ₐ} |

Using the rate allocation output of Algorithm 4, any increase in the rate of any user will incur a decrease in the rate of some other user in order for the rate vector to remain decodable and thus, R* is the pareto-optimal solution.

In order to address the case when the MLD is employed at each secondary receiver, Algorithm 4MLD can be used and which can be initialized with any rate vector Rₘᵢₙ that is decodable when the MLD is employed at each receiver.

Pseudo-code for Algorithm 4MLD is as follows:

Algorithm 4MLD-Distributed Weighted Max-Min Fair
Rate Allocation for MLD

| | |
|---|---|
| 1: | Initialize R^{min} and q = 0 |
| 2: | repeat |
| 3: | for i = 1, . . . , Mₛ do |
| 4: | Initialize [symbol] = [symbol] |
| 5: | repeat |

| | |
|---|---|
| 6: | $Find δ = {min}_{B : i ε B , B ⊆ 𝒮} \frac{Δ ( {h}^{i} , B , 0 , {R}^{min} )}{{\sum }_{j ε B} {ρ}_{j}}$ |
| 7: | $B = arg {min}_{B : i ε B , B ⊆ 𝒮} \frac{Δ ( {h}^{i} , B , 0 , {R}^{min} )}{{\sum }_{j ε B} {ρ}_{j}}$ |

| | |
|---|---|
| 8: | rⱼⁱ = δ_{ρ}_{ⱼ} for all j ε [symbol] |
| 9: | [symbol] ← [symbol] \ [symbol] |

| | |
|---|---|
| 10: | until [symbol] = 0 |
| 11: | end for |
| 12: | Update q ← q + 1 and Rₖ^{(q)} = Rₖ^{min} + min_{1≦i≦M}_{ₛ} {rₖⁱ} and |
| | R^{min} ← R^{(q)} |
| 13: | until R^{(q)} converges |
| 14: | Output R^{ML} = R^{(q)} |

The rate allocation R^{ML} yielded by Algorithm 4MLD is also pareto-optimal and the algorithm has the following properties:
1) It is monotonic in the sense that R^{(q+1)} [symbol] R^{(q)} and is convergent.
2) At each iteration the vector R^{(q)} is max-min optimal i.e. for any other arbitrary rate vector \tilde{R} [symbol] R^{min} that is decodable using the MILD at each receiver,

$${min}_{k ∈ K} \frac{{R}_{k}^{( q )} - {R}_{k}^{min}}{{ρ}_{k}} \geq {min}_{k ∈ K} \frac{{\tilde{R}}_{k} - {R}_{k}^{min}}{{ρ}_{k}} , ∀ q \geq 1.$$

3) The rate allocation R^{ML} yielded by Algorithm 4 is also pareto-optimal, i.e., for any arbitrary rate vector \tilde{R} [symbol] R^{min} decodable using the MLD at each receiver, such that \tilde{R}ₖ>Rₖ^{ML} for some kεκ, ∃j≠k: \tilde{R}ⱼ<Rⱼ^{ML}.

The above system considers decentralized multi-antenna cognitive radio networks where secondary transceivers co-exist with primary ones. Distributed algorithms are used for optimal beamforming and rate allocation in such networks. The system can be optimized for cases when the secondary receivers employ single-user decoders, maximum likelihood decoders and unconstrained group decoders, respectively. An optimal distributed algorithm handles the case when each secondary receiver employs single-user decoding. The algorithm is optimal in the sense that it provides beamformers that maximize the minimum weighted rate subject to a weighted sum power budget for the secondary users and interference margin constraints imposed by the primary users. A centralized sub-optimal algorithm can be used for the case when each secondary receiver employs the maximum likelihood decoder. Finally, for the case with advanced decoders at the secondary receivers (MLD or UGD) and a given choice of beamformers, distributed low-complexity fair rate allocation algorithms are provided boost the system efficiency and maintain a notion of fairness.

In one embodiment, a low complexity distributed beamforming can be done. The distributed beamforming can be used for the case when single user decoding is used by each receiver. In this embodiment, hᵢⱼ denote the channel vector from the j^{th} transmitter to the i^{th} receiver after normalization by the standard deviation of the thermal noise and weak interference at the i^{th} receiver. Each transmitter employs beamforming to communicate with its desired receiver. The beam vector employed by the j^{th} transmitter is denoted by wⱼ and comprises of beam magnitude ∥wⱼ∥ and beam direction wⱼ/∥wⱼ∥ The restriction in this embodiment is that the set of possible beam directions and the set of possible beam magnitudes that each transmitter can employ are both finite. In particular the j^{th} transmitter can choose any beam direction from the set Dj and any magnitude from the set Mj. However, the beams employed by all transmitters (each beam is the product of the beam direction and the beam magnitude) must respect the interference margin constraints imposed by each primary receiver. The sets Dj and Mj can be any pre-defined finite sets that are known in advance to the j^{th} transceiver. They can also be constructed based on the channel vectors impacting the j^{th} transceiver. In particular, the system classifies all channel vectors impacting the j^{th} transceiver as the set of “outgoing” channels {hᵢⱼ} for all i, and the set of “incoming” channels {hⱼᵢ} for all i. Note that the “incoming” channels are seen by the j^{th} receiver and the “outgoing” channels correspond to channels between the j^{th} transmitter and other receivers. Then, a simple way to construct a finite set Dj is

$$\{ \frac{{( {\sum }_{i ∈ Δ} {h}_{ij}^{H} {h}_{ij} + {\sum }_{i ∈ {Ω}_{j}} {h}_{ij}^{H} {h}_{ij} + {α}_{j} I )}^{- 1} {h}_{jj}^{H}}{‖ {( {\sum }_{i ∈ Δ} {h}_{ij}^{H} {h}_{ij} + {\sum }_{i ∈ {Ω}_{j}} {h}_{ij}^{H} {h}_{ij} + {α}_{j} I )}^{- 1} {h}_{jj}^{H} ‖} \}$$

where, the superscript H denotes conjugate transpose. Δ is any subset of the primary receivers {1, . . . , Mp} and Ωⱼ is any subset of secondary receivers {1, . . . , Ms} not including j and the set Dj is formed by considering all possible such Δ, Ωⱼ. αⱼ is any positive scalar used for regularization.

Next, an appropriate metric is defined for the j^{th} secondary transceiver, referred to as metrics. Henceforth, the term secondary is omitted and “transceivers” mean secondary transceivers unless stated otherwise. Examples of metricⱼ include SINRⱼ which is computed as

$${SINR}_{j} = \frac{{‖ {h}_{jj} {w}_{j} ‖}^{2}}{1 + {\sum }_{k \neq j} {\vert {h}_{jk} {w}_{k} ‖}^{2}}$$

or any function of SINRⱼ or any other appropriate function of the set of outgoing and incoming channels of the j^{th} transceiver and the beams employed by all transmitters.

A system metric that is a function of all the metrics of all transceivers is defined. Each transceiver can determine the system metric if it knows the metrics of all transceivers and an example of the system metric is min{metricⱼ} where the minimum is over all transceivers. The objective is to maximize the system metric. The following iterative low-complexity distributed procedures can be employed to select beams for all transceivers. The procedures can be employed at the transmitters. It is assumed that the transmitters can exchange messages among themselves.

Each transmitter j has estimates of all incoming and outgoing channels associated with transceiver j. Then, given the beams employed by all other transmitters, it can compute its own metric. Moreover, for any choice of its beam wⱼ it can also compute the interference it causes to any other receiver i, ∥hᵢⱼwⱼ∥². Using this interference along with some other additional information from transceiver i (such as the total interference power as well as the desired signal power seen by receiver i), the system can compute an estimate of the metric of transceiver i. Moreover, with appropriate additional information, each transmitter can also determine if its beam choice is valid i.e., if the chosen beam is such that the interference margins at all primary receivers is respected, given the beams employed by other transmitters. In the following algorithms the system is initialized with a valid choice of beam at each transmitter.

In one embodiment, the system implements the following pseudo-code:
Repeat
At each transmitter j:
   1. Obtain the set of beams employed by other transmitters along with other additional information which is sufficient to compute an estimate of the difference between the system metric with the current choice of beam by transmitter j and that with any other choice of beam by transmitter j, under the assumption that the other transmitters do not change their beams. Moreover, the additional information is enough to determine the validity of any beam of transmitter j also under the assumption that the other transmitters do not change their beams.
   2. Compute an estimate of the difference between the system metric for each valid choice of beam direction and magnitude from the sets Dj and Mj, respectively, and the current system metric system metric, under the assumption that the other transmitters do not change their beams and select the choice that maximizes the system metric (best choice).
   3. Accept the best choice with a probability which is one if the current choice is the best choice and can be any pre-determined and fixed strictly positive number less than 1 otherwise.
   4. If the best choice is accepted then broadcast the best choice along with additional information to all other transmitters.
Until convergence or a pre-determined number of iterations.

Another implementation is given below:
Repeat
At a designated transmitter, generate an index whose value lies in {1, . . . , Ms} using a pre-determined probability distribution. Broadcast the index and suppose the generated index is j. Then, the transmitters other than j do not change their beams.
At transmitter j:
   1. Obtain the set of beams employed by other transmitters along with other additional information which is sufficient to compute an estimate of the difference between the system metric with the current choice of beam by transmitter j and that with any other choice of beam by transmitter j, under the assumption that the other transmitters do not change their beams. Moreover, the additional information is enough to determine the validity of any beam of transmitter j also under the assumption that the other transmitters do not change their beams.
   2. Generate a random choice of beam direction and magnitude from the sets Dj and Mj, respectively, distinct from the current choice, using a pre-determined and fixed probability distribution over the sets Dj and Mj and compute the difference between the system metric for the generated random choice and the current system metric, if the random choice is valid.
   3. Accept the random choice if it is valid, with a probability that is a pre-determined function of the iteration number and the difference between the system metric with the random choice and the current system metric.
   4. If the random choice is accepted then broadcast the random choice along with additional information to all other transmitters. Send the new system metric to the designated transmitter.
Until convergence or a pre-determined number of iterations.

There are several ways to reduce the overhead associated with the signaling among transmitters. First, if the channel vector hᵢⱼ from the j^{th} transmitter to the i^{th} receiver is has a small enough norm, i.e. if ∥hᵢⱼ∥ is small enough, then for any choice of beam by the j^{th} transmitter, the interference caused to the i^{th} receiver will be small enough. Consequently, the i^{th} receiver may assume an average value of interference from the j^{th} transmitter which is computed by averaging ∥hᵢⱼwⱼ∥² over all beams that can be used by transmitter j. Further, in the aforementioned procedures, the j^{th} transmitter need not convey the choice of its beam to transmitter i. Also, the j^{th} transmitter does not have to compute any metric corresponding to the i^{th} transceiver so that any additional information intended only to facilitate that metric computation does not have to sent by transmitter i to transmitter j.

The other main overhead reduction can be achieved from compressing the additional information that is exchanged among transmitters. There is a tradeoff between compression and the accuracy of the estimate that is computed at each transmitter. The compressed additional information should permit step-1 in either of the two algorithms given above. Some examples of reducing the overhead of signaling the additional information are given below. For convenience, the SINR metric is used for each transceiver and the system metric is the worst-case or minimum SINR among all Ms transceivers.

The evaluation of metrics at transmitter j includes evaluating j's own metric for any valid choice of beam wⱼ, which is given by:

$${SINR}_{j} = \frac{{‖ {h}_{jj} {w}_{j} ‖}^{2}}{1 + {\sum }_{k \neq j} {\vert {h}_{jk} {w}_{k} ‖}^{2}} .$$

Having knowledge of the beams used by other transmitters and all incoming and outgoing channels impacting transceiver j allows transmitter j to compute SINRⱼ. Instead SINRⱼ can also be computed if the term ∥hⱼₖwₖ∥² is received from every other transmitter k. Each transmitter j has estimated the terms {∥hⱼₖwₖ∥²} after obtaining the beams used by every other transmitter k or obtained them directly from every other transmitter k.

Next the estimation of SINRᵢ at transmitter j is discussed. SINRᵢ can be written as

$${SINR}_{i} = \frac{{‖ {h}_{ii} {w}_{i} ‖}^{2}}{1 + {‖ {h}_{ij} {w}_{j} ‖}^{2} + {\sum }_{k \neq i , j} {\vert {h}_{ik} {w}_{k} ‖}^{2}}$$

If estimates of all its outgoing channels are available to transmitter j, it can compute the term ∥hᵢⱼwⱼ∥² for any choice of its beam wⱼ. Thus, if the terms ∥hᵢᵢwᵢ∥², Σ_{k≠i,j}|hᵢₖwₖ∥² are sent by transmitter i to transmitter j, it can compute SINRᵢ. Also, note that for any primary receiver p, if the secondary transmitter j knows the term Σ_{k≠j}|hₚₖwₖ∥² along with the interference margin for primary receiver p, it can determine the validity of any choice of its beam. Finally, each transmitter j can obtain estimates of all incoming and outgoing channels associated with transceiver j as follows. In systems where channel reciprocity can be exploited, each receiver can broadcast pilots (or known training symbols) using which each transmitter can estimate all its outgoing channels. All transmitters can also broadcast pilots using which each receiver can estimate all its incoming channels. Transmitters can exchange some of their estimates with other transmitters so that all of them can acquire estimates of all the incoming channels associated with their respective intended receivers. In systems where reciprocity is not (or cannot be) exploited, each receiver can send estimates of all its incoming channels to its designated transmitter, which can then exchange some of its estimates with other transmitters.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations, which although not explicitly shown or described herein, embody the principles of the invention and are within their spirit and scope.

What is claimed is:

1. A method for designing beamforming vectors for and allocating transmission rates to secondary users in a wireless cognitive network with secondary (cognitive) users and primary (license-holding) users, comprising:
performing distributed beamforming design and rate allocation for the secondary users to maximize a minimum weighted secondary rate; and
granting simultaneous spectrum access to the primary and secondary users subject to one or more co-existence constraints.

2. The method of claim 1, comprising satisfying a weighted sum-power budget for the secondary users and an interference margin constraint imposed by each primary user.

3. The method of claim 1, comprising performing single-user decoding at each secondary receiver.

4. The method of claim 3, wherein each secondary receiver employs a minimum mean-squared error (MMSE) based decoder.

5. The method of claim 3, wherein each secondary receiver decodes only signals transmitted by its designated transmitter after suppressing the remaining signals.

6. The method of claim 5, wherein signals are suppressed through linear filtering.

7. The method of claim 1, wherein each secondary user employs a maximum likelihood decoder (MLD) to jointly decode all secondary transmissions.

8. The method of claim 1, wherein each secondary user employs an unconstrained group decoder (UGD) to jointly decode the desired secondary transmission along with any subset of other secondary transmissions.

9. The method of claim 1, comprising:
generating a beamformer for each secondary user and
allocating excess rates to the secondary users beyond their minimum acceptable rates, for a generated beamformers, such that weighted max-min fairness is maintained.

10. The method of claim 9, wherein each secondary user is decodable at its respective receiver.

11. The method of claim 1, wherein each secondary user carries out its beamformer design in a distributed fashion, with limited message passing among secondary transceiver pairs.

12. A method for allocating transmission rates in a wireless network where secondary (cognitive) users are granted simultaneous spectrum access along with primary (license-holding) users, comprising:
determining the beamformers and rates in a distributed fashion for the case when single user decoding is employed at each secondary receiver; and
performing distributed allocation of excess rates to the secondary users, for a predetermined beamformer, wherein the excess rate allocation maintains a notion of fairness.

13. A wireless system, comprising:
a plurality of users, each having a transmitter and a receiver, wherein secondary users are allowed to use the spectrum or bandwidth licensed to primary users concurrently and wherein secondary transmitter beamformers are designed to ensure that the interference seen by individual primary receivers does not exceed a specified level, wherein a minimum quality of service (QoS) is guaranteed for each secondary user and wherein a weighted sum of powers used by the secondary transmitters is minimized or a worst case QoS among all cognitive users is maximized.

14. The system of claim 13, comprising performing single-user decoding at each secondary receiver and wherein each secondary receiver employs a minimum mean-squared error (MMSE) based decoder.

15. The system of claim 14, wherein each secondary receiver decodes only signals transmitted by its designated transmitter after suppressing the remaining signals through linear filtering.

16. The system of claim 13, wherein each secondary user employs a maximum likelihood decoder (MLD) to jointly decode all secondary transmissions or an unconstrained group decoder (UGD) to jointly decode the desired secondary transmission along with any subset of other secondary transmissions.

17. The system of claim 13, wherein each secondary user first generates a beamformer for its transceiver and then excess rates are allocated to the secondary users in a distributed manner beyond their minimum acceptable rates, such that weighted max-min fairness is maintained.

18. The system of claim 13, wherein each secondary transmitter employs beamforming to communicate with a desired receiver while ensuring that an aggregate interference to each primary receiver is below a specified level (interference margin).

19. The method of claim 14 wherein a beamformer for each secondary transmitter is selected from a finite set of beams in a distributed manner with limited message passing among the transmitters.

20. The method of claim 19 wherein a finite set of beams used by a secondary transmitter can be constructed using estimates of the channels between that transmitter and some or all receivers.

21. The method of claim 19 where secondary beamformers are selected using iterative distributed processing in which between successive iterations, a most-recent tentative beam vector selected by each secondary transmitter along with associated additional information is exchanged among secondary transmitters.

22. The method of claim 21 where additional information obtained at each transmitter is sufficient to compute an estimate of a difference between a system metric with the current choice of beam by that transmitter and with any other choice of beam by the transmitter, under an assumption that other transmitters do not change their beams.

23. The method of claim 21 where additional information obtained at each transmitter is sufficient to determine validity with respect to interference margins of primary receivers, of any beam of that transmitter under an assumption that other transmitters do not change their beams.
